(19) United States
(12) Patent Application Publication
(10) Pub. No.: US 2024/0305710 A1
(43) Pub. Date: Sep. 12, 2024

(54) MANAGING QUALITY FOR VIDEO SERVICE

(71) Applicant: QUALCOMM INCORPORATED, San Diego, CA (US)

(72) Inventors: Bing LENG, Shanghai (CN); Liang XUE, Beijing (CN); Chao CHEN, Shenzhen (CN); Shuhong WANG, Shanghai (CN); Yuting WANG, Shenzhen (CN)

(21) Appl. No.: 18/262,096

(22) PCT Filed: Apr. 3, 2021
(86) PCT No.: PCT/CN2021/085489

§ 371 Date: Jul. 19, 2023

(51) Int. Cl. H04M 3/22; H04N 21/258; H04N 21/2662; H04N 21/4788

(52) U.S. Cl. CPC H04M 3/2227; H04N 21/25833; H04N 21/2662; H04N 21/4788; H04M 2201/50

(57) ABSTRACT

Methods, systems, and devices for wireless communications are described. A user equipment (UE) may transmit a request to a network entity to establish a voice communication session with another UE that may be subscribed to a video service. The UE may transmit an indication of a video streaming parameter for the video service for streaming one-way video transmissions from the network entity to the UE for display during establishment of the voice communication session. The UE may transmit an indication of an updated video streaming parameter to the network entity to reduce the video quality for the video service. The network entity may reduce the video streaming quality for the one or more one-way video transmissions to the UE based on the updated video streaming parameter.

### CROSS REFERENCE

The present Application is a 371 national stage filing of International PCT Application No. PCT/CN2021/085489 by LENG et al. entitled “MANAGING QUALITY FOR VIDEO SERVICE,” filed Apr. 3, 2021, which is assigned to the assignee hereof, and which is expressly incorporated by reference in its entirety herein.

### FIELD OF TECHNOLOGY

The following relates to wireless communications, including managing quality for video service.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support managing quality for video service. Generally, the described techniques provide for a user equipment (UE) to transmit an indication of an updated video streaming parameter to a network entity to reduce the video quality or streaming parameters for a video service. For example, the UE may determine a video streaming quality at the UE fails to satisfy a threshold value for one or more one-way video transmissions. The UE may send an updated video streaming parameter to the network entity (e.g., a base station) based on the video streaming quality failing to satisfy the threshold value. In some cases, the base station may reduce the video streaming quality or some video streaming parameters for the one or more one-way video transmissions to the UE based on the updated video streaming parameter.

A method for wireless communications at a first UE is described. The method may include transmitting a request to a network entity to establish a voice communication session with a second UE, transmitting an indication to the network entity of a first video streaming parameter associated with a video service, where the video service is configured for streaming one-way video transmissions from the network entity to the first UE for display at the first UE during establishment of the voice communication session with the second UE based on a subscription of the second UE to the video service, receiving one-way video transmissions associated with the video service during the establishment of the voice communication session with the second UE, the one-way video transmissions having a first video quality at the first UE, and transmitting an indication of a second video streaming parameter associated with the video service based on the first video quality at the first UE failing to satisfy a threshold video quality at the first UE for the video service.

An apparatus for wireless communications at a first UE is described. The apparatus may include a processor, memory coupled with the processor, and instructions stored in the memory. The instructions may be executable by the processor to cause the apparatus to transmit a request to a network entity to establish a voice communication session with a second UE, transmit an indication to the network entity of a first video streaming parameter associated with a video service, where the video service is configured for streaming one-way video transmissions from the network entity to the first UE for display at the first UE during establishment of the voice communication session with the second UE based on a subscription of the second UE to the video service, receive one-way video transmissions associated with the video service during the establishment of the voice communication session with the second UE, the one-way video transmissions having a first video quality at the first UE, and transmit an indication of a second video streaming parameter associated with the video service based on the first video quality at the first UE failing to satisfy a threshold video quality at the first UE for the video service.

Another apparatus for wireless communications at a first UE is described. The apparatus may include means for transmitting a request to a network entity to establish a voice communication session with a second UE, means for transmitting an indication to the network entity of a first video streaming parameter associated with a video service, where the video service is configured for streaming one-way video transmissions from the network entity to the first UE for display at the first UE during establishment of the voice communication session with the second UE based on a subscription of the second UE to the video service, means for receiving one-way video transmissions associated with the video service during the establishment of the voice communication session with the second UE, the one-way video transmissions having a first video quality at the first UE, and means for transmitting an indication of a second video streaming parameter associated with the video service based on the first video quality at the first UE failing to satisfy a threshold video quality at the first UE for the video service.

A non-transitory computer-readable medium storing code for wireless communications at a first UE is described. The code may include instructions executable by a processor to transmit a request to a network entity to establish a voice communication session with a second UE, transmit an indication to the network entity of a first video streaming parameter associated with a video service, where the video service is configured for streaming one-way video transmissions from the network entity to the first UE for display at the first UE during establishment of the voice communication session with the second UE based on a subscription of the second UE to the video service, receive one-way video transmissions associated with the video service during the establishment of the voice communication session with the second UE, the one-way video transmissions having a first video quality at the first UE, and transmit an indication of a second video streaming parameter associated with the video service based on the first video quality at the first UE failing to satisfy a threshold video quality at the first UE for the video service.

Some examples of the method, apparatuses, and non-transitory computer-readable medium described herein may further include operations, features, means, or instructions for determining a timer corresponding to the video service and transmitting the indication of the second video streaming parameter based on the first video quality at the first UE failing to satisfy the threshold video quality for a duration of the timer.

Some examples of the method, apparatuses, and non-transitory computer-readable medium described herein may further include operations, features, means, or instructions for starting the timer based on transmitting the request to establish the voice communication session and determining the first video quality fails to satisfy the threshold video quality prior to expiration of the timer, where transmitting the indication of the second video streaming parameter may be based on determining the first video quality fails to satisfy the threshold video quality prior to expiration of the timer.

Some examples of the method, apparatuses, and non-transitory computer-readable medium described herein may further include operations, features, means, or instructions for restarting the timer based on transmitting the indication of the second video streaming parameter prior to expiration of the timer, receiving the one-way video transmissions associated with the video service according to a second video quality, determining the second video quality fails to satisfy the second video streaming parameter prior to expiration of the restarted timer, and transmitting an additional indication of a third video streaming parameter based on the determining.

Some examples of the method, apparatuses, and non-transitory computer-readable medium described herein may further include operations, features, means, or instructions for receiving the one-way video transmissions associated with the video service according to a second video quality based on transmitting the indication of the second video streaming parameter, the second video quality satisfying the second video streaming parameter.

Some examples of the method, apparatuses, and non-transitory computer-readable medium described herein may further include operations, features, means, or instructions for receiving the one-way video transmissions associated with the video service according to a second video quality based on transmitting the indication of the second video streaming parameter, determining the second video quality fails to satisfy the second video streaming parameter, and transmitting an additional indication of a third video streaming parameter based on determining the second video quality fails to satisfy the second video streaming parameter.

Some examples of the method, apparatuses, and non-transitory computer-readable medium described herein may further include operations, features, means, or instructions for determining that the second video streaming parameter includes a lowest configured video streaming parameter for the first UE and transmitting, to the network entity, an indication to disable the video service based on the second video streaming parameter including the lowest configured video streaming parameter for the first UE.

In some examples of the method, apparatuses, and non-transitory computer-readable medium described herein, the first video streaming parameter, the second video streaming parameter, or both include a supported codec and a profile level corresponding to a bitrate supported by the first UE associated with receiving the one-way video transmissions.

In some examples of the method, apparatuses, and non-transitory computer-readable medium described herein, the first video streaming parameter, the second video streaming parameter, or both include a quality of service (QOS), a bandwidth, a bit rate, a video resolution, or a combination thereof.

In some examples of the method, apparatuses, and non-transitory computer-readable medium described herein, the video service may be a customized alerting tone (CAT) service.

### BRIEF DESCRIPTION OF THE DRAWINGS

FIGS. 1 and 2 illustrates examples of wireless communications systems that support managing quality for video service in accordance with aspects of the present disclosure.

FIG. 3 illustrates an example of a process flow that supports managing quality for video service in accordance with aspects of the present disclosure.

FIGS. 4 and 5 show block diagrams of devices that support managing quality for video service in accordance with aspects of the present disclosure.

FIG. 6 shows a block diagram of a communications manager that supports managing quality for video service in accordance with aspects of the present disclosure.

FIG. 7 shows a diagram of a system including a device that supports managing quality for video service in accordance with aspects of the present disclosure.

FIGS. 8 through 10 show flowcharts illustrating methods that support managing quality for video service in accordance with aspects of the present disclosure.

### DETAILED DESCRIPTION

In some wireless communications systems, a user equipment (UE) may establish a connection with another device, such as another UE, for packet-based communication, such as a voice call, a video call, or the like. In some examples, the other UE may subscribe to a video service (e.g., a customized alerting tone (CAT) service) for streaming one-way video transmission from a network entity, such as a base station, to the UE. The UE may receive one-way video transmissions from the base station while the connection is being established, such as while a voice call is ringing. That is, if the other UE is subscribed to the video streaming service, a base station, or a network, may send, to the UE making the call, a request with resources for one or more video data packets supported for the video streaming service. However, when the base station sends video data packets to the UE, the downlink video data packets may be dropped or may not be scheduled because the video service may not meet the quality of the video data packets (e.g., due to available bandwidth, environmental conditions, or both).

As described herein, a UE may send an indication of an updated video quality parameter to reduce a video quality for a video streaming service. For example, the UE may establish a wireless connection with a wireless device, such as another UE that may be subscribed to a video service. The UE may support a threshold video quality, such as a bandwidth, a bit rate, a resolution, a quality of service (QOS), or a combination thereof for receiving one or more downlink video transmissions from a network entity. The UE may receive the downlink video transmissions for a duration while establishing the wireless connection and initiating exchange of data packets with the other UE (e.g., while a voice call or video call is connecting). If the downlink video transmissions do not satisfy the threshold video quality, the UE may transmit an indication of an updated video streaming parameter to the base station. The base station may reduce the video quality for the downlink video transmissions based on reducing the video quality, so the UE may receive the downlink video transmissions. In some examples, the UE may transmit the request according to a timer, such as if a dropping rate of the downlink video transmission fails to satisfy the threshold video quality within or for the duration of the timer. If the reduced video quality still fails to satisfy the threshold video quality at the UE, the UE may transmit additional indications to reduce the video quality and may eventually disable the video streaming service if a lowest threshold video quality is not met.

Aspects of the disclosure are initially described in the context of wireless communications systems. Aspects of the disclosure are further described in the context of a process flow. Aspects of the disclosure are further illustrated by and described with reference to apparatus diagrams, system diagrams, and flowcharts that relate to managing quality for video service.

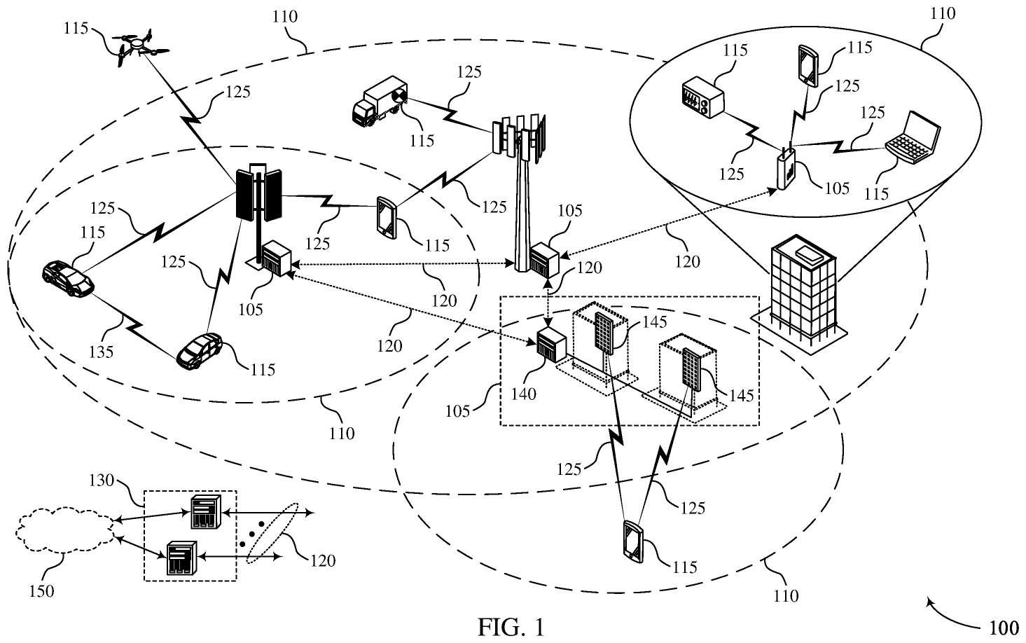

FIG. 1 illustrates an example of a wireless communications system 100 that supports managing quality for video service in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some cases, a UE 115 may establish a communication session with another wireless device, such as another UE 115, for packet-based communication. For example, the UE 115 may transmit a communication session request to a network entity, such as a base station 105, to establish packet-based communication with another UE 115 during the communication session. The packet-based communications may include a voice call, a video call, or the like. In some examples, the other wireless device may subscribe to a video streaming service, which may be a video CAT service, in which the UE 115 receives one or more one-way video transmissions while establishing the communication session (e.g., while a voice call is ringing). In some cases, the UE 115 may support a video quality for the one or more one-way video transmissions of the video service. In some examples, the base station 105 may use a highest resolution of an indicated video streaming parameter for the one or more one-way video transmissions to the UE 115. However, if the one-way video transmissions are dropped at the UE 115 or if the base station 105 fails to schedule the one-way video transmissions, the UE 115 may fail to receive the one-way video transmissions for the voice service (e.g., the video displayed to the user of the UE 115 may freeze or be pixelated).

In some examples, a UE 115 may transmit an indication of an updated video streaming parameter to a network entity to reduce the video quality or some video streaming parameters for a video service. For example, the UE 115 may determine a video streaming quality fails to satisfy a threshold value for the one or more one-way video transmissions. The UE 115 may send an updated video streaming parameter to the base station 105 based on the video streaming quality failing to satisfy the threshold value. In some cases, the base station 105 may reduce the video streaming quality for the one or more one-way video transmissions to the UE 115 based on the updated video streaming parameter.

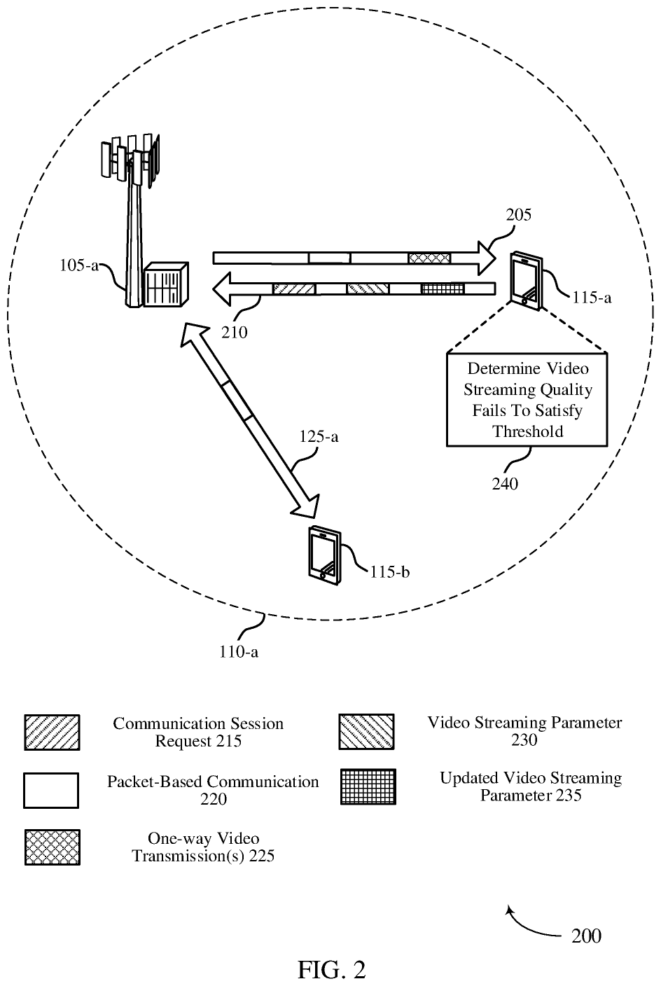

FIG. 2 illustrates an example of a wireless communications system 200 that supports managing quality for video service in accordance with aspects of the present disclosure. In some cases, wireless communications system 200 may implement aspects of wireless communications system 100 and may include UE 115-a, UE 115-b, communication link 125-a, and base station 105-a with coverage area 110-a, which may be examples of UEs 115, a communication link 125, and a base station 105 with a coverage area 110 as described with reference to FIG. 1. In some cases, a UE 115 may receive control signaling, data, or both, from a base station 105 via a downlink communication link 205. Similarly, the UE 115 may transmit control signaling, data, or both, to the base station 105 via an uplink communication link 210. In some examples, the UE 115 may indicate to a network entity, such as the base station 105, to downgrade a video quality for a video service during establishment of a communication session with another wireless device.

In some cases, a UE 115 may establish a communication session with another wireless device, such as another UE 115, for packet-based communication 220. For example, UE 115-a may transmit a communication session request 215 to a network entity, such as base station 105-a via uplink communication link 210, to establish packet-based communication 220 with UE 115-b during the communication session. The packet-based communications may include a voice call, a video call, or the like. For example, UE 115-a may coordinate with base station 105-a to exchange packet-based communication 220 with UE 115-b. That is, UE 115-a may transmit one or more data packets to UE 115-b via an uplink communication link 210, may receive one or more data packets from UE 115-b via a downlink communication link 205, or both during the communication session. Similarly, UE 115-b may transmit or receive one or more packets to or from UE 115-a, respectively, via communication link 125-a.

In some examples, the other wireless device may subscribe to a video streaming service, which may be a video CAT service, in which the UE 115 receives one or more one-way video transmissions 225 while establishing the communication session (e.g., while a voice call is ringing). A network entity, such as base station 105-a, may send the one-way video transmissions 225 to the UE 115 for a duration between when the UE sends a communication session request 215 to establish a communication session and when the communication session is initiated (e.g., a user of the other wireless device answers a voice call). If a user of a wireless device (e.g., a called party) subscribes to the video CAT service from an operator, when an originating UE 115 initiates a voice call, the network entity may send a request to the originating UE 115 with a set of supported video codecs for the one-way video transmissions 225. For example, if UE 115-b subscribes to the video streaming service, when UE 115-a sends the communication session request 215 to base station 105-a, base station 105-a may send supported video codecs for the one-way video transmissions 225. In some examples, base station 105-a may include an indication of the video codecs based on negotiating a session description protocol (SDP) for the video service.

In some cases, UE 115-a may support one or more video parameter for one-way video transmissions 225 of the video service. For example, UE 115-a may support one or more video codecs or profile-levels, which may indicate a maximum level or preferred level supported by the UE 115. In some cases, UE 115-a may transmit an indication of a video streaming parameter 230 for the video service to base station 105-a, such as a supported video profile-level, an indication of one or more supported codecs for the one-way video transmissions 225, or both. Additionally or alternatively, the video streaming parameter 230 may indicate a quality of service (QOS), highest or preferred bandwidth, a highest or preferred bit rate, video resolution, or a combination thereof.

In some examples, a base station 105 may initially use a highest resolution of an indicated video streaming parameter 230, such as a maximum profile-level, for the one or more one-way video transmissions 225 (e.g., the video CAT media data) to a UE 115. However, when the base station 105 sends the one or more one-way video transmissions 225 to the UE 115, the video transmissions including downlink video data may be dropped or otherwise experience decoding errors at the UE 115. In some other cases, the base station 105 may not have enough radio resource to schedule one-way video transmissions 225 because the network environment may be loaded or may have relatively high interference (e.g., causing a relatively large video jitter delay of the downlink video data), the base station 105 may operate according to a bandwidth capacity, or the like. If the one-way video transmissions 225 are dropped at the UE 115 or if the base station 105 fails to schedule the one-way video transmissions 225, the UE 115 may fail to receive the one-way video transmissions 225 for the voice service (e.g., the video displayed to the user of the UE 115 may freeze or otherwise become pixilated).

In some examples, a UE 115 may transmit an indication of an updated video streaming parameter 235 to a network entity to reduce the video quality for a video service. For example, at 240, UE 115-a may determine a video streaming quality fails to satisfy a threshold value for the one or more one-way video transmissions 225. UE 115-a may send an updated video streaming parameter 235 to base station 105-a based on the video streaming quality failing to satisfy the threshold value. The updated video streaming parameter may include an updated supported profile-level ID, an indication of one or more updated supported video codecs parameter for the one-way video transmissions 225, or both. Additionally or alternatively, the updated video streaming parameter 235 may indicate an updated threshold QoS, an updated threshold bandwidth, an updated threshold bit rate, an updated threshold video resolution, or a combination thereof. In some cases, base station 105-a may reduce the video streaming quality for the one or more one-way video transmissions 225 to UE 115-a based on the updated video streaming parameter 235. In this way, due to the reduced streaming quality, the one-way video transmission 225 may appear more clearly at the UE 115-a, thereby improving user experience.

In some examples, the network entity may mark a video stream as a one-way video stream prior to sending the one-way video transmissions 225 to UE 115-a. For example, base station 105-a may mark the video stream as send-only with an attribute in an SDP of a request before sending video data to UE 115-a. UE 115-a may not send a temporary maximum media stream bit rate request (TMMBR) to base station 105-a to request a network to limit a maximum bit rate for the video stream when downlink video data dropping may be present, such as when UE 115-a drops one-way video transmissions 225. Thus, when the downlink video packet loss is above a threshold value, video quality may be reduced at UE 115-a. Additionally or alternatively, an operator may define multiple video formats for the video service (e.g., a video CAT service). For example, an operator may define a profile level (e.g., H.264 profile 3.1, which may be 2160 kilobits per second (kbps) at a 280 by 720 point resolution and H.264 profile 3.0, which may be 960 kbps at a 640 by 480 point resolution). In some examples, base station 105-a may reduce the bandwidth for a resolution. For example, base station 105-a may reduce a highest resolution supported by UE 115-a, such as 2160 kbps at a 1280 by 720 point resolution, to a lower resolution, such as 960 kbps at a 640 by 480 point resolution. In some examples, a video service server (e.g., a CAT server) may not know UE 115-a has video packet loss for one-way video transmissions 225 because the video service server may not receive a TMMBR message (e.g., a real-time transport protocol (RTP) control protocol (RTCP) TMMBR message).

In some examples, UE 115-a may determine a timer for the one-way video transmissions 225. For example, base station 105-a may transmit an indication of the timer to UE 115-a. In some other examples, UE 115-a may determine the timer based on a configuration (e.g., a preconfigured value at the UE 115-a). UE 115-a may define the timer and a threshold for downlink video data detection, such as detection of one-way video transmissions 225. If UE 115-a detects a drop rate of downlink video data packets is greater than the threshold within or for a duration of the timer, UE 115-a may send a request to base station 105-a to update the resolution of the one-way video transmissions 225. For example, UE 115-a may request for base station 105-a to downgrade a video quality of the one-way video transmissions 225. The request may include a lower level for a profile level, such as a reduced video profile level. In some cases, the CAT server, which may be at a network entity such as base station 105-a, may accordingly downgrade a resolution and bit rate of the video stream for one-way video transmission 225 to UE 115-a.

In some examples, the timer may be configured based on a UE ring-back timer. The downlink video packet dropping rate may be defined per profile level. For example, the dropping rate may be based on the for RTP video packets (e.g., at profile level H.264, profile level H.263, profile level H.265, or a combination thereof) that UE 115-a does not receive. In some other examples, the dropping rate may be based on the for RTP video packets (e.g., at profile level H.264, profile level H.263, profile level H.265, or a combination thereof) that UE 115-a receives but may not be able to play due to jitter or for other reasons. Base station 105-a may update the video quality for one-way video transmissions 225 based on a new profile level (e.g., a reduced profile level) or an updated codec (e.g., changing a codec level to level 3 when a dropping rate is greater than 3% in 2 seconds).

In some examples, if UE 115-a continues to observe downlink video packet dropping (e.g., dropping one-way video transmissions 225), UE 115-a may send one or more additional updates, such as one or more additional updated video streaming parameters 235 to update a profile level, codec, or one or more bitrate related to video quality. In some examples, UE 115-a may continue to send additional updates based on conditions for an operator. UE 115-a may disable the video service (e.g., video CAT media) by updating a video port parameter, such as setting the parameter to a value of 0, if the updated parameters are no longer supported at UE 115-a. That is, if a lowest configured video streaming threshold for UE 115-a is not met, UE 115-a may disable the video service. Updating the video streaming parameters may improve user experience for the video service and cause power saving related to the resolution and bit rate downgrade for the one or more one-way video transmissions 225.

In some examples, UE 115-a may continue to receive the one-way video transmissions 225 until the communication session is established with UE 115-b. For example, UE 115-b may accept a voice call, and base station 105-a may disable the one-way video transmissions 225. Once the communication session is established, UE 115-a and UE 115-b may exchange one or more data packets for the packet-based communication 220.

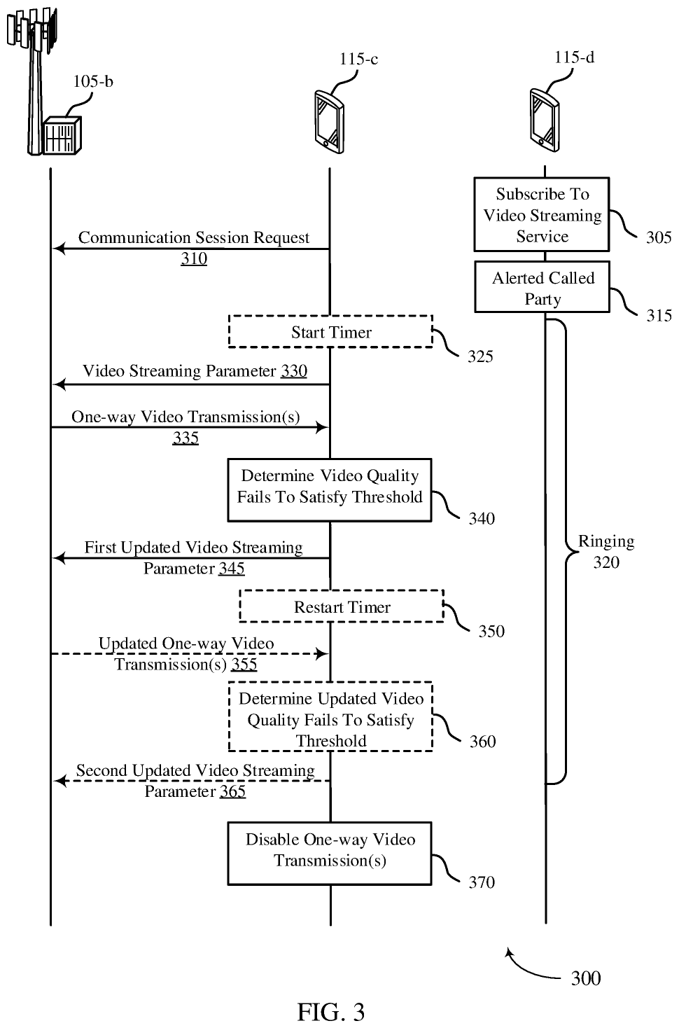

FIG. 3 illustrates an example of a process flow 300 that supports managing quality for video service in accordance with aspects of the present disclosure. In some examples, process flow 300 may implement aspects of wireless communications system 100 and wireless communications system 200. The process flow 300 may illustrate a UE 115, such as UE 115-c, sending an indication to a network entity, such as base station 105-b, to reduce a video quality for a video streaming service so the video quality satisfies a threshold. Alternative examples of the following may be implemented, where some processes are performed in a different order than described or are not performed. In some cases, processes may include additional features not mentioned below, or further processes may be added.

At 305, UE 115-d may subscribe to a video streaming service. For example, UE 115-d may subscribe to a video CAT service, such that an operator may send one or more one-way video transmissions to other wireless devices during a period in which packet-based communications are being established (e.g., while a voice call is ringing) with UE 115-d. That is, if UE 115-c request to establish a voice call with UE 115-d, a user of UE 115-c may view a video service while the voice call is ringing at UE 115-d.

At 310, UE 115-c may transmit a communication session request to a network entity, such as base station 105-b, to establish a voice communication session with UE 115-d. In some cases, the video service may be configured for streaming one-way video transmissions from base station 105-b to UE 115-c for display at UE 115-c during establishment of the voice communication session with UE 115-d. Base station 105-b may send the one-way video transmissions if UE 115-d is subscribed to the video service.

In some examples, the communication session request may initiate a series of messages between one or more components or functions at base station 105-b, such as a serving-call session control function (S-CSCF), a CAT access server (CAT-AS), or both. For example, UE 115-c may send an invite message to the S-CSCF. The S-CSCF may send the invite message to the CAT-AS and UE 115-d. The S-CSCF, CAT-AS, UE 115-c, and UE 115-d may exchange one or more session progress messages and provisional response acknowledgement (PRACK) messages based on one or more available resources at UE 115-c, UE 115-d, or both. In some cases, the CAT-AS may reserve one or more CAT resources, such as time-frequency resources for one or more one-way video transmissions.

At 315, UE 115-d may be an alerted called party. For example, base station 105-b may transmit an alert to a called party (e.g., UE 115-d). In some cases, base station 105-b may transmit an indication that UE 115-c is attempting to establish a communication session for packet-based communication with UE 115-d. The packet-based communication may be a voice call, a video call, or the like. The alert may trigger ringing at UE 115-d.

For example, at 320, UE 115-d may ring if the packet-based communication is a voice call or a video call. The ringing may occur for a duration at UE 115-d. For example, the ringing may continue until UE 115-d acknowledges the communication session request from a network entity.

In some cases, UE 115-c may determine a timer for the video service. For example, UE 115-c may receive an indication of the timer from base station 105-b. In some other examples, the timer may be otherwise configured or determined by UE 115-c (e.g., preconfigured).

At 325, UE 115-c may start the timer based on transmitting the communication session request to establish the voice communication session with UE 115-d. In some examples, UE 115-c may determine whether a downlink packet dropping rate is greater than a threshold within the timer or for a duration of the timer.

At 330, UE 115-c may transmit a video streaming parameter to base station 105-b. In some cases, the video streaming parameter may be a first video streaming parameter for a video service.

At 335, UE 115-c may receive a one-way video transmissions for the video service during the establishment of the voice communication session with UE 115-d. In some cases, the one-way video transmissions may have a first video quality at UE 115-c.

At 340, UE 115-c may determine the first video quality fails to satisfy the threshold video quality. For example, UE 115-c may determine the first video quality fails to satisfy the threshold video quality prior to expiration of the timer or for a duration of the timer.

At 345, UE 115-c may transmit a first updated video streaming parameter for the video service based on the first video quality at UE 115-c failing to satisfy a threshold video quality at UE 115-c for the video service. In some cases, the video streaming parameter may be an indication of a second video streaming threshold for the video service. In some cases, UE 115-c may transmit the indication of the second video streaming threshold based on determining the first video quality fails to satisfy the threshold video quality prior to expiration of the timer. In some examples, the first updated video streaming parameter may reduce a profile-level of a video profile to be used for the video service.

At 350, UE 115-c may restart the timer based on transmitting the indication of the second video streaming threshold prior to the expiration of the timer.

At 355, UE 115-c may receive updated one-way video transmissions for the video service according to a second video quality. In some cases, UE 115-c may receive the one-way video transmissions for the video service according to a second video quality based on transmitting the indication of the second video streaming threshold. That is, base station 105-b may downgrade or otherwise reduce a resolution of the one-way video transmissions, a bit rate of the video stream for the one-way video transmissions, or both. In some cases, the second video quality may satisfy the second video streaming threshold. In some other cases, the second video quality may fail to satisfy the second video streaming threshold.

For example, at 360, UE 115-c may determine the second video quality fails to satisfy the second video streaming threshold. In some cases, UE 115-c may determine the second video quality fails to satisfy the second video streaming threshold prior to expiration of the restarted timer or for a duration of the restarted timer.

At 365, UE 115-c may transmit an additional indication of a second updated video streaming parameter. In some cases, the parameter may be a third video streaming threshold based on the determination that the updated video quality fails to satisfy the second video streaming threshold.

At 370, UE 115-c may determine that the second video streaming parameter includes a lowest configured video streaming profile or bitrate (e.g., a lowest threshold supported by the UE 115-c, the base station 105-b, or both) and may disable the video service based on the determination. For example, the packet loss rate for lowest video profile at UE 115-c may not meet the threshold, and may disable the video service rather than continuing to update the video streaming parameter. In some examples, disabling the video service may include the UE 115-c sending a request to disable or terminate the video service.

In some cases, the first video streaming parameter, the second video streaming parameter, or both may include a supported codec and a profile level for a bitrate supported by UE 115-c for receiving the one-way video transmissions. Additionally or alternatively, the first video streaming parameter, the second video streaming parameter, or both may include a threshold quality of service, a highest or preferred bandwidth, highest or preferred bit rate, highest or preferred video resolution, or a combination thereof.

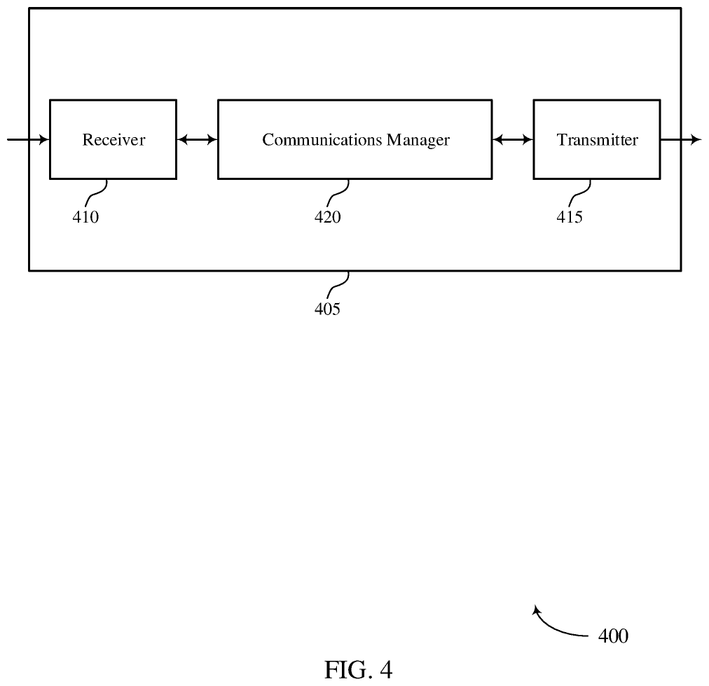

FIG. 4 shows a block diagram 400 of a device 405 that supports managing quality for video service in accordance with aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to managing quality for video service). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to managing quality for video service). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of managing quality for video service as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 420 may be configured to perform various operations (e.g., receiving, monitoring, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to receive information, transmit information, or perform various other operations as described herein.

The communications manager 420 may support wireless communications at a first UE in accordance with examples as disclosed herein. For example, the communications manager 420 may be configured as or otherwise support a means for transmitting a request to a network entity to establish a voice communication session with a second UE. The communications manager 420 may be configured as or otherwise support a means for transmitting an indication to the network entity of a first video streaming parameter associated with a video service, where the video service is configured for streaming one-way video transmissions from the network entity to the first UE for display at the first UE during establishment of the voice communication session with the second UE based on a subscription of the second UE to the video service. The communications manager 420 may be configured as or otherwise support a means for receiving one-way video transmissions associated with the video service during the establishment of the voice communication session with the second UE, the one-way video transmissions having a first video quality at the first UE. The communications manager 420 may be configured as or otherwise support a means for transmitting an indication of a second video streaming parameter associated with the video service based on the first video quality at the first UE failing to satisfy a threshold video quality at the first UE for the video service.

By including or configuring the communications manager 420 in accordance with examples as described herein, the device 405 (e.g., a processor controlling or otherwise coupled to the receiver 410, the transmitter 415, the communications manager 420, or a combination thereof) may support techniques for a UE to send an indication of an updated video streaming parameter to reduce a video quality for a video streaming service, which may reduce processing, reduce power consumption, cause more efficient utilization of communication resources, and the like.

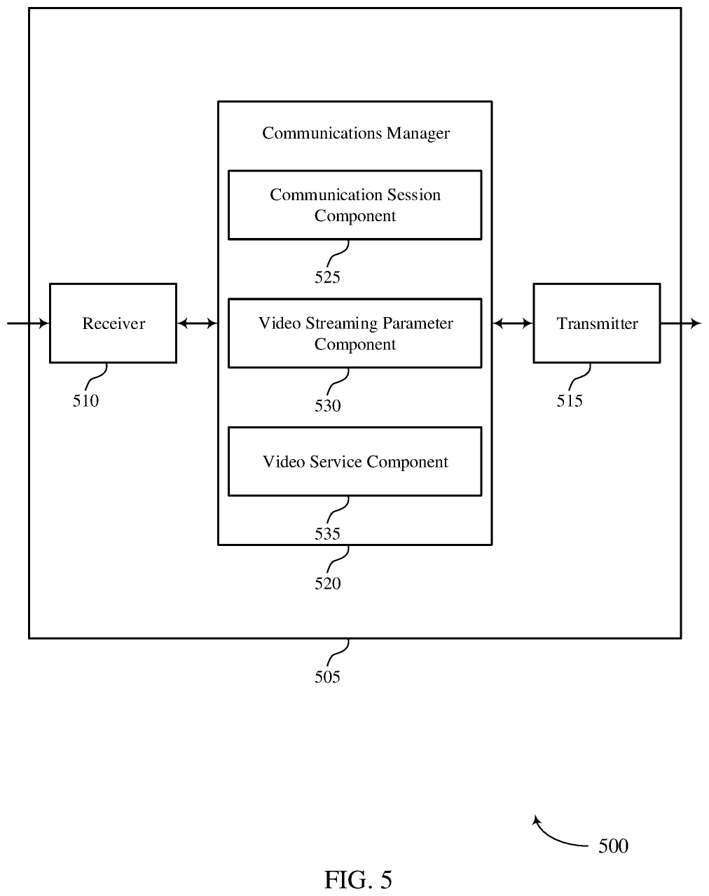

FIG. 5 shows a block diagram 500 of a device 505 that supports managing quality for video service in accordance with aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to managing quality for video service). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to managing quality for video service). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of managing quality for video service as described herein. For example, the communications manager 520 may include a communication session component 525, a video streaming parameter component 530, a video service component 535, or any combination thereof. The communications manager 520 may be an example of aspects of a communications manager 420 as described herein. In some examples, the communications manager 520, or various components thereof, may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communications at a first UE in accordance with examples as disclosed herein. The communication session component 525 may be configured as or otherwise support a means for transmitting a request to a network entity to establish a voice communication session with a second UE. The video streaming parameter component 530 may be configured as or otherwise support a means for transmitting an indication to the network entity of a first video streaming parameter associated with a video service, where the video service is configured for streaming one-way video transmissions from the network entity to the first UE for display at the first UE during establishment of the voice communication session with the second UE based on a subscription of the second UE to the video service. The video service component 535 may be configured as or otherwise support a means for receiving one-way video transmissions associated with the video service during the establishment of the voice communication session with the second UE, the one-way video transmissions having a first video quality at the first UE. The video streaming parameter component 530 may be configured as or otherwise support a means for transmitting an indication of a second video streaming parameter associated with the video service based on the first video quality at the first UE failing to satisfy a threshold video quality at the first UE for the video service.

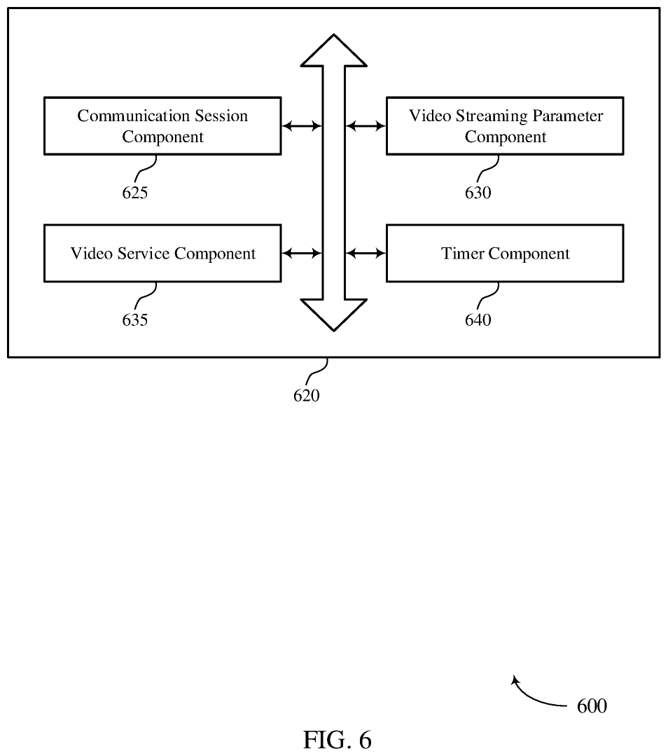

FIG. 6 shows a block diagram 600 of a communications manager 620 that supports managing quality for video service in accordance with aspects of the present disclosure. The communications manager 620 may be an example of aspects of a communications manager 420, a communications manager 520, or both, as described herein. The communications manager 620, or various components thereof, may be an example of means for performing various aspects of managing quality for video service as described herein. For example, the communications manager 620 may include a communication session component 625, a video streaming parameter component 630, a video service component 635, a timer component 640, or any combination thereof. Each of these components may communicate, directly or indirectly, with one another (e.g., via one or more buses).

The communications manager 620 may support wireless communications at a first UE in accordance with examples as disclosed herein. The communication session component 625 may be configured as or otherwise support a means for transmitting a request to a network entity to establish a voice communication session with a second UE. The video streaming parameter component 630 may be configured as or otherwise support a means for transmitting an indication to the network entity of a first video streaming parameter associated with a video service, where the video service is configured for streaming one-way video transmissions from the network entity to the first UE for display at the first UE during establishment of the voice communication session with the second UE based on a subscription of the second UE to the video service. The video service component 635 may be configured as or otherwise support a means for receiving one-way video transmissions associated with the video service during the establishment of the voice communication session with the second UE, the one-way video transmissions having a first video quality at the first UE. In some examples, the video streaming parameter component 630 may be configured as or otherwise support a means for transmitting an indication of a second video streaming parameter associated with the video service based on the first video quality at the first UE failing to satisfy a threshold video quality at the first UE for the video service.

In some examples, the timer component 640 may be configured as or otherwise support a means for determining a timer corresponding to the video service. In some examples, the timer component 640 may be configured as or otherwise support a means for transmitting the indication of the second video streaming parameter based on the first video quality at the first UE failing to satisfy the threshold video quality for a duration of the timer.

In some examples, the timer component 640 may be configured as or otherwise support a means for starting the timer based on transmitting the request to establish the voice communication session. In some examples, the timer component 640 may be configured as or otherwise support a means for determining the first video quality fails to satisfy the threshold video quality prior to expiration of the timer, where transmitting the indication of the second video streaming parameter is based on determining the first video quality fails to satisfy the threshold video quality prior to expiration of the timer.

In some examples, the timer component 640 may be configured as or otherwise support a means for restarting the timer based on transmitting the indication of the second video streaming parameter prior to expiration of the timer. In some examples, the video service component 635 may be configured as or otherwise support a means for receiving the one-way video transmissions associated with the video service according to a second video quality. In some examples, the timer component 640 may be configured as or otherwise support a means for determining the second video quality fails to satisfy the second video streaming parameter prior to expiration of the restarted timer. In some examples, the video streaming parameter component 630 may be configured as or otherwise support a means for transmitting an additional indication of a third video streaming parameter based on the determining.

In some examples, the video service component 635 may be configured as or otherwise support a means for receiving the one-way video transmissions associated with the video service according to a second video quality based on transmitting the indication of the second video streaming parameter, the second video quality satisfying the second video streaming parameter.

In some examples, the video service component 635 may be configured as or otherwise support a means for receiving the one-way video transmissions associated with the video service according to a second video quality based on transmitting the indication of the second video streaming parameter. In some examples, the video service component 635 may be configured as or otherwise support a means for determining the second video quality fails to satisfy the second video streaming parameter. In some examples, the video streaming parameter component 630 may be configured as or otherwise support a means for transmitting an additional indication of a third video streaming parameter based on determining the second video quality fails to satisfy the second video streaming parameter.

In some examples, the video streaming parameter component 630 may be configured as or otherwise support a means for determining that the second video streaming parameter includes a lowest configured video streaming threshold for the first UE. In some examples, the video service component 635 may be configured as or otherwise support a means for transmitting, to the network entity, an indication to disable the video service based on the second video streaming parameter including the lowest configured video streaming threshold for the first UE.

In some examples, the first video streaming parameter, the second video streaming parameter, or both include a supported codec and a profile level corresponding to a bitrate supported by the first UE associated with receiving the one-way video transmissions.

In some examples, the first video streaming parameter, the second video streaming parameter, or both include a threshold QoS, a threshold bandwidth, a threshold bit rate, a threshold video resolution, or a combination thereof.

In some examples, the video service is a customized alerting tone service.

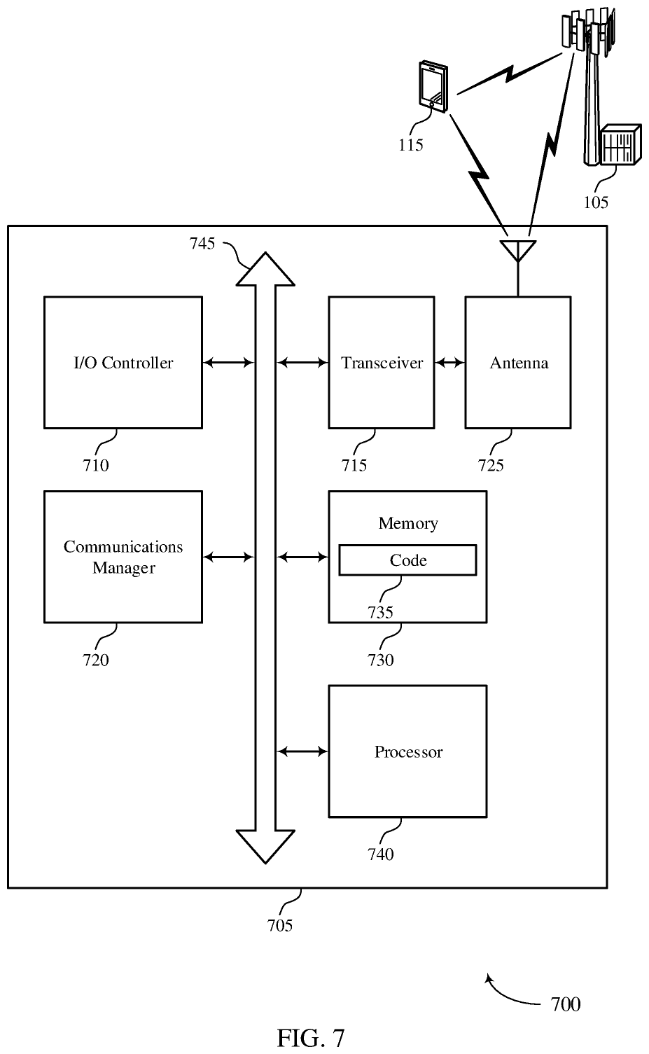

FIG. 7 shows a diagram of a system 700 including a device 705 that supports managing quality for video service in accordance with aspects of the present disclosure. The device 705 may be an example of or include the components of a device 405, a device 505, or a UE 115 as described herein. The device 705 may communicate wirelessly with one or more base stations 105, UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting managing quality for video service). For example, the device 705 or a component of the device 705 may include a processor 740 and memory 730 coupled to the processor 740, the processor 740 and memory 730 configured to perform various functions described herein.

The communications manager 720 may support wireless communications at a first UE in accordance with examples as disclosed herein. For example, the communications manager 720 may be configured as or otherwise support a means for transmitting a request to a network entity to establish a voice communication session with a second UE. The communications manager 720 may be configured as or otherwise support a means for transmitting an indication to the network entity of a first video streaming parameter associated with a video service, where the video service is configured for streaming one-way video transmissions from the network entity to the first UE for display at the first UE during establishment of the voice communication session with the second UE based on a subscription of the second UE to the video service. The communications manager 720 may be configured as or otherwise support a means for receiving one-way video transmissions associated with the video service during the establishment of the voice communication session with the second UE, the one-way video transmissions having a first video quality at the first UE. The communications manager 720 may be configured as or otherwise support a means for transmitting an indication of a second video streaming parameter associated with the video service based on the first video quality at the first UE failing to satisfy a threshold video quality at the first UE for the video service.

By including or configuring the communications manager 720 in accordance with examples as described herein, the device 705 may support techniques for a UE to send an indication of an updated video streaming parameter to reduce a video quality for a video streaming service, which may improve communication reliability, reduce latency, improve user experience related to reduced processing, reduce power consumption, cause more efficient utilization of communication resources, improve coordination between devices, increase battery life, improve utilization of processing capability, and the like.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of managing quality for video service as described herein, or the processor 740 and the memory 730 may be otherwise configured to perform or support such operations.

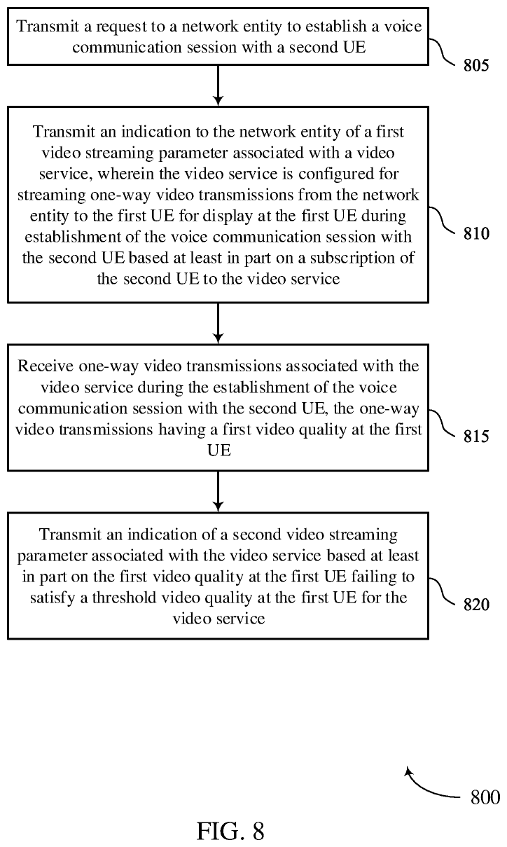

FIG. 8 shows a flowchart illustrating a method 800 that supports managing quality for video service in accordance with aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 805, the method may include transmitting a request to a network entity to establish a voice communication session with a second UE. The operations of 805 may be performed in accordance with examples as disclosed herein. In some examples, aspects of the operations of 805 may be performed by a communication session component 625 as described with reference to FIG. 6.

At 810, the method may include transmitting an indication to the network entity of a first video streaming parameter associated with a video service, where the video service is configured for streaming one-way video transmissions from the network entity to the first UE for display at the first UE during establishment of the voice communication session with the second UE based on a subscription of the second UE to the video service. The operations of 810 may be performed in accordance with examples as disclosed herein. In some examples, aspects of the operations of 810 may be performed by a video streaming parameter component 630 as described with reference to FIG. 6.

At 815, the method may include receiving one-way video transmissions associated with the video service during the establishment of the voice communication session with the second UE, the one-way video transmissions having a first video quality at the first UE. The operations of 815 may be performed in accordance with examples as disclosed herein. In some examples, aspects of the operations of 815 may be performed by a video service component 635 as described with reference to FIG. 6.

At 820, the method may include transmitting an indication of a second video streaming parameter associated with the video service based on the first video quality at the first UE failing to satisfy a threshold video quality at the first UE for the video service. The operations of 820 may be performed in accordance with examples as disclosed herein. In some examples, aspects of the operations of 820 may be performed by a video streaming parameter component 630 as described with reference to FIG. 6.

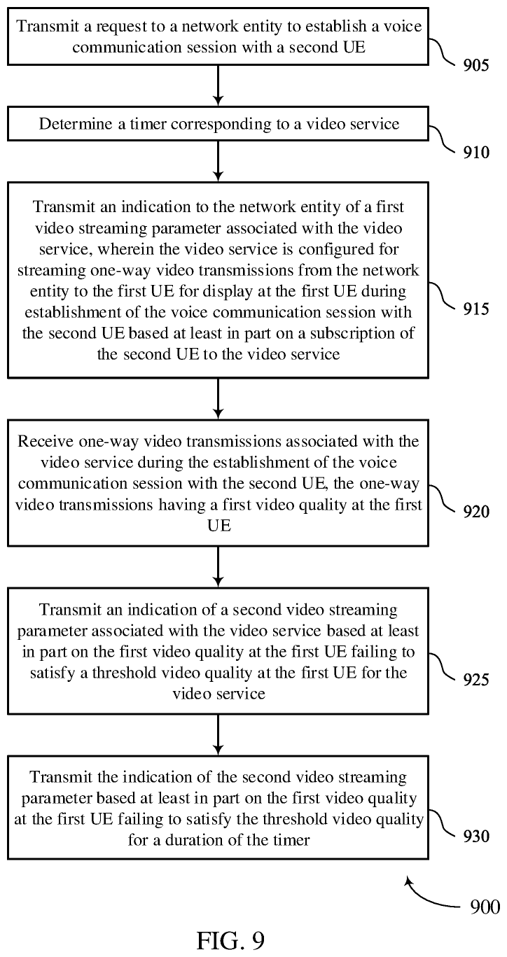

FIG. 9 shows a flowchart illustrating a method 900 that supports managing quality for video service in accordance with aspects of the present disclosure. The operations of the method 900 may be implemented by a UE or its components as described herein. For example, the operations of the method 900 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 905, the method may include transmitting a request to a network entity to establish a voice communication session with a second UE. The operations of 905 may be performed in accordance with examples as disclosed herein. In some examples, aspects of the operations of 905 may be performed by a communication session component 625 as described with reference to FIG. 6.

At 910, the method may include determining a timer corresponding to a video service. The operations of 910 may be performed in accordance with examples as disclosed herein. In some examples, aspects of the operations of 910 may be performed by a timer component 640 as described with reference to FIG. 6.

At 915, the method may include transmitting an indication to the network entity of a first video streaming parameter associated with the video service, where the video service is configured for streaming one-way video transmissions from the network entity to the first UE for display at the first UE during establishment of the voice communication session with the second UE based on a subscription of the second UE to the video service. The operations of 915 may be performed in accordance with examples as disclosed herein. In some examples, aspects of the operations of 915 may be performed by a video streaming parameter component 630 as described with reference to FIG. 6.

At 920, the method may include receiving one-way video transmissions associated with the video service during the establishment of the voice communication session with the second UE, the one-way video transmissions having a first video quality at the first UE. The operations of 920 may be performed in accordance with examples as disclosed herein. In some examples, aspects of the operations of 920 may be performed by a video service component 635 as described with reference to FIG. 6.

At 925, the method may include transmitting an indication of a second video streaming parameter associated with the video service based on the first video quality at the first UE failing to satisfy a threshold video quality at the first UE for the video service. The operations of 925 may be performed in accordance with examples as disclosed herein. In some examples, aspects of the operations of 925 may be performed by a video streaming parameter component 630 as described with reference to FIG. 6.

At 930, the method may include transmitting the indication of the second video streaming parameter based on the first video quality at the first UE failing to satisfy the threshold video quality for a duration of the timer. The operations of 930 may be performed in accordance with examples as disclosed herein. In some examples, aspects of the operations of 930 may be performed by a timer component 640 as described with reference to FIG. 6.

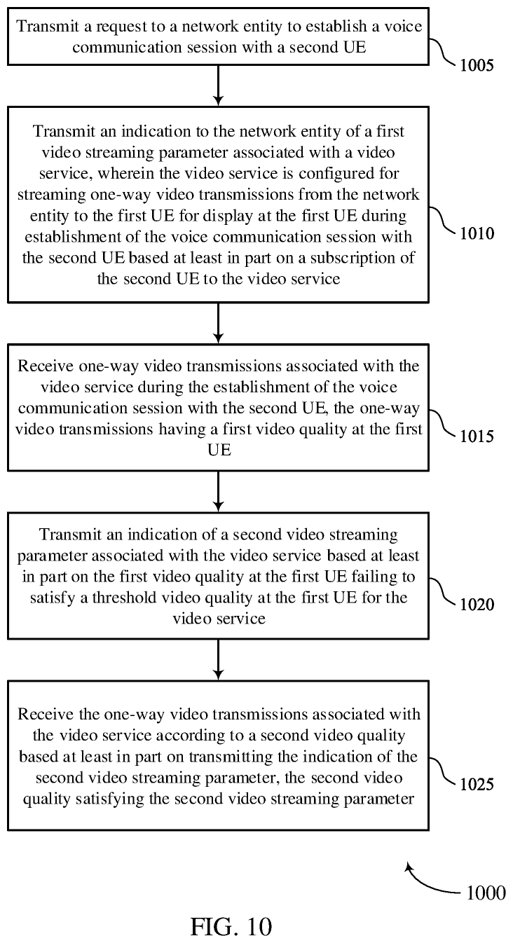

FIG. 10 shows a flowchart illustrating a method 1000 that supports managing quality for video service in accordance with aspects of the present disclosure. The operations of the method 1000 may be implemented by a UE or its components as described herein. For example, the operations of the method 1000 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1005, the method may include transmitting a request to a network entity to establish a voice communication session with a second UE. The operations of 1005 may be performed in accordance with examples as disclosed herein. In some examples, aspects of the operations of 1005 may be performed by a communication session component 625 as described with reference to FIG. 6.

At 1010, the method may include transmitting an indication to the network entity of a first video streaming parameter associated with a video service, where the video service is configured for streaming one-way video transmissions from the network entity to the first UE for display at the first UE during establishment of the voice communication session with the second UE based on a subscription of the second UE to the video service. The operations of 1010 may be performed in accordance with examples as disclosed herein. In some examples, aspects of the operations of 1010 may be performed by a video streaming parameter component 630 as described with reference to FIG. 6.

At 1015, the method may include receiving one-way video transmissions associated with the video service during the establishment of the voice communication session with the second UE, the one-way video transmissions having a first video quality at the first UE. The operations of 1015 may be performed in accordance with examples as disclosed herein. In some examples, aspects of the operations of 1015 may be performed by a video service component 635 as described with reference to FIG. 6.

At 1020, the method may include transmitting an indication of a second video streaming parameter associated with the video service based on the first video quality at the first UE failing to satisfy a threshold video quality at the first UE for the video service. The operations of 1020 may be performed in accordance with examples as disclosed herein. In some examples, aspects of the operations of 1020 may be performed by a video streaming parameter component 630 as described with reference to FIG. 6.

At 1025, the method may include receiving the one-way video transmissions associated with the video service according to a second video quality based on transmitting the indication of the second video streaming parameter, the second video quality satisfying the second video streaming parameter. The operations of 1025 may be performed in accordance with examples as disclosed herein. In some examples, aspects of the operations of 1025 may be performed by a video service component 635 as described with reference to FIG. 6.

The following provides an overview of aspects of the present disclosure:

Aspect 1: A method for wireless communications at a first UE, comprising: transmitting a request to a network entity to establish a voice communication session with a second UE; transmitting an indication to the network entity of a first video streaming parameter associated with a video service, wherein the video service is configured for streaming one-way video transmissions from the network entity to the first UE for display at the first UE during establishment of the voice communication session with the second UE based at least in part on a subscription of the second UE to the video service; receiving one-way video transmissions associated with the video service during the establishment of the voice communication session with the second UE, the one-way video transmissions having a first video quality at the first UE; and transmitting an indication of a second video streaming parameter associated with the video service based at least in part on the first video quality at the first UE failing to satisfy a threshold video quality at the first UE for the video service.

Aspect 2: The method of aspect 1, further comprising: determining a timer corresponding to the video service; and transmitting the indication of the second video streaming parameter based at least in part on the first video quality at the first UE failing to satisfy the threshold video quality for a duration of the timer.

Aspect 3: The method of aspect 2, further comprising: starting the timer based at least in part on transmitting the request to establish the voice communication session; and determining the first video quality fails to satisfy the threshold video quality prior to expiration of the timer, wherein transmitting the indication of the second video streaming parameter is based at least in part on determining the first video quality fails to satisfy the threshold video quality prior to expiration of the timer.

Aspect 4: The method of aspect 3, further comprising: restarting the timer based at least in part on transmitting the indication of the second video streaming parameter prior to expiration of the timer; receiving the one-way video transmissions associated with the video service according to a second video quality; determining the second video quality fails to satisfy the second video streaming parameter prior to expiration of the restarted timer; and transmitting an additional indication of a third video streaming parameter based at least in part on the determining.

Aspect 5: The method of any of aspects 1 through 4, further comprising: receiving the one-way video transmissions associated with the video service according to a second video quality based at least in part on transmitting the indication of the second video streaming parameter, the second video quality satisfying the second video streaming parameter.

Aspect 6: The method of any of aspects 1 through 5, further comprising: receiving the one-way video transmissions associated with the video service according to a second video quality based at least in part on transmitting the indication of the second video streaming parameter; and determining the second video quality fails to satisfy the second video streaming parameter; and transmitting an additional indication of a third video streaming parameter based at least in part on determining the second video quality fails to satisfy the second video streaming parameter.

Aspect 7: The method of any of aspects 1 through 6, further comprising: determining that the second video streaming parameter comprises a lowest configured video streaming parameter for the first UE; and transmitting, to the network entity, an indication to disable the video service based at least in part on the second video streaming parameter comprising the lowest configured video streaming parameter for the first UE.

Aspect 8: The method of any of aspects 1 through 7, wherein the first video streaming parameter, the second video streaming parameter, or both comprise a supported codec and a profile level corresponding to a bitrate supported by the first UE associated with receiving the one-way video transmissions.

Aspect 9: The method of any of aspects 1 through 8, wherein the first video streaming parameter, the second video streaming parameter, or both comprise a quality of service, a bandwidth, a bit rate, a video resolution, or a combination thereof.

Aspect 10: The method of any of aspects 1 through 9, wherein the video service is a customized alerting tone service.

Aspect 11: An apparatus for wireless communications at a first UE, comprising a processor; memory coupled with the processor; and instructions stored in the memory and executable by the processor to cause the apparatus to perform a method of any of aspects 1 through 10.

Aspect 12: An apparatus for wireless communications at a first UE, comprising at least one means for performing a method of any of aspects 1 through 10.

Aspect 13: A non-transitory computer-readable medium storing code for wireless communications at a first UE, the code comprising instructions executable by a processor to perform a method of any of aspects 1 through 10.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a first user equipment (UE), comprising:
transmitting a request to a network entity to establish a voice communication session with a second UE;
transmitting an indication to the network entity of a first video streaming parameter associated with a video service, wherein the video service is configured for streaming one-way video transmissions from the network entity to the first UE for display at the first UE during establishment of the voice communication session with the second UE based at least in part on a subscription of the second UE to the video service;
receiving one-way video transmissions associated with the video service during the establishment of the voice communication session with the second UE, the one-way video transmissions having a first video quality at the first UE; and
transmitting an indication of a second video streaming parameter associated with the video service based at least in part on the first video quality at the first UE failing to satisfy a threshold video quality at the first UE for the video service.

2. The method of claim 1, further comprising:
determining a timer corresponding to the video service; and
transmitting the indication of the second video streaming parameter based at least in part on the first video quality at the first UE failing to satisfy the threshold video quality for a duration of the timer.

3. The method of claim 2, further comprising:
starting the timer based at least in part on transmitting the request to establish the voice communication session; and
determining the first video quality fails to satisfy the threshold video quality prior to expiration of the timer, wherein transmitting the indication of the second video streaming parameter is based at least in part on determining the first video quality fails to satisfy the threshold video quality prior to expiration of the timer.

4. The method of claim 3, further comprising:
restarting the timer based at least in part on transmitting the indication of the second video streaming parameter prior to expiration of the timer;
receiving the one-way video transmissions associated with the video service according to a second video quality;
determining the second video quality fails to satisfy the second video streaming parameter prior to expiration of the restarted timer; and
transmitting an additional indication of a third video streaming parameter based at least in part on the determining.

5. The method of claim 1, further comprising:
receiving the one-way video transmissions associated with the video service according to a second video quality based at least in part on transmitting the indication of the second video streaming parameter, the second video quality satisfying the second video streaming parameter.

6. The method of claim 1, further comprising:
receiving the one-way video transmissions associated with the video service according to a second video quality based at least in part on transmitting the indication of the second video streaming parameter; and
determining the second video quality fails to satisfy the second video streaming parameter; and
transmitting an additional indication of a third video streaming parameter based at least in part on determining the second video quality fails to satisfy the second video streaming parameter.

7. The method of claim 1, further comprising:
determining that the second video streaming parameter comprises a lowest configured video streaming parameter for the first UE; and
transmitting, to the network entity, an indication to disable the video service based at least in part on the second video streaming parameter comprising the lowest configured video streaming parameter for the first UE.

8. The method of claim 1, wherein the first video streaming parameter, the second video streaming parameter, or both comprise a supported codec and a profile level corresponding to a bitrate supported by the first UE associated with receiving the one-way video transmissions.

9. The method of claim 1, wherein the first video streaming parameter, the second video streaming parameter, or both comprise a quality of service, a bandwidth, a bit rate, a video resolution, or a combination thereof.

10. The method of claim 1, wherein the video service is a customized alerting tone service.

11. An apparatus for wireless communications at a first user equipment (UE), comprising:
a processor;
memory coupled with the processor; and
instructions stored in the memory and executable by the processor to cause the apparatus to:
transmit a request to a network entity to establish a voice communication session with a second UE;
transmit an indication to the network entity of a first video streaming parameter associated with a video service, wherein the video service is configured for streaming one-way video transmissions from the network entity to the first UE for display at the first UE during establishment of the voice communication session with the second UE based at least in part on a subscription of the second UE to the video service;
receive one-way video transmissions associated with the video service during the establishment of the voice communication session with the second UE, the one-way video transmissions having a first video quality at the first UE; and
transmit an indication of a second video streaming parameter associated with the video service based at least in part on the first video quality at the first UE failing to satisfy a threshold video quality at the first UE for the video service.

12. The apparatus of claim 11, wherein the instructions are further executable by the processor to cause the apparatus to:
determine a timer corresponding to the video service; and
transmit the indication of the second video streaming parameter based at least in part on the first video quality at the first UE failing to satisfy the threshold video quality for a duration of the timer.

13. The apparatus of claim 12, wherein the instructions are further executable by the processor to cause the apparatus to:
start the timer based at least in part on transmitting the request to establish the voice communication session; and
determine the first video quality fails to satisfy the threshold video quality prior to expiration of the timer, wherein transmitting the indication of the second video streaming parameter is based at least in part on determining the first video quality fails to satisfy the threshold video quality prior to expiration of the timer.

14. The apparatus of claim 13, wherein the instructions are further executable by the processor to cause the apparatus to:
restart the timer based at least in part on transmitting the indication of the second video streaming parameter prior to expiration of the timer;
receive the one-way video transmissions associated with the video service according to a second video quality;
determine the second video quality fails to satisfy the second video streaming parameter prior to expiration of the restarted timer; and
transmit an additional indication of a third video streaming parameter based at least in part on the determining.

15. The apparatus of claim 11, wherein the instructions are further executable by the processor to cause the apparatus to:
receive the one-way video transmissions associated with the video service according to a second video quality based at least in part on transmitting the indication of the second video streaming parameter, the second video quality satisfying the second video streaming parameter.

16. The apparatus of claim 11, wherein the instructions are further executable by the processor to cause the apparatus to:
receive the one-way video transmissions associated with the video service according to a second video quality based at least in part on transmitting the indication of the second video streaming parameter; and
determine the second video quality fails to satisfy the second video streaming parameter; and
transmit an additional indication of a third video streaming parameter based at least in part on determining the second video quality fails to satisfy the second video streaming parameter.

17. The apparatus of claim 11, wherein the instructions are further executable by the processor to cause the apparatus to:
determine that the second video streaming parameter comprises a lowest configured video streaming threshold for the first UE; and
transmit, to the network entity, an indication to disable the video service based at least in part on the second video streaming parameter comprising the lowest configured video streaming threshold for the first UE.

18. The apparatus of claim 11, wherein the first video streaming parameter, the second video streaming parameter, or both comprise a supported codec and a profile level corresponding to a bitrate supported by the first UE associated with receiving the one-way video transmissions.

19. The apparatus of claim 11, wherein the first video streaming parameter, the second video streaming parameter, or both comprise a threshold quality of service, a bandwidth, a bit rate, a video resolution, or a combination thereof.

20. The apparatus of claim 11, wherein the video service is a customized alerting tone service.

21. An apparatus for wireless communications at a first user equipment (UE), comprising:
means for transmitting a request to a network entity to establish a voice communication session with a second UE;
means for transmitting an indication to the network entity of a first video streaming parameter associated with a video service, wherein the video service is configured for streaming one-way video transmissions from the network entity to the first UE for display at the first UE during establishment of the voice communication session with the second UE based at least in part on a subscription of the second UE to the video service;
means for receiving one-way video transmissions associated with the video service during the establishment of the voice communication session with the second UE, the one-way video transmissions having a first video quality at the first UE; and
means for transmitting an indication of a second video streaming parameter associated with the video service based at least in part on the first video quality at the first UE failing to satisfy a threshold video quality at the first UE for the video service.

22. The apparatus of claim 21, further comprising:
means for determining a timer corresponding to the video service; and
means for transmitting the indication of the second video streaming parameter based at least in part on the first video quality at the first UE failing to satisfy the threshold video quality for a duration of the timer.

23. The apparatus of claim 22, further comprising:
means for starting the timer based at least in part on transmitting the request to establish the voice communication session; and
means for determining the first video quality fails to satisfy the threshold video quality prior to expiration of the timer, wherein transmitting the indication of the second video streaming parameter is based at least in part on determining the first video quality fails to satisfy the threshold video quality prior to expiration of the timer.

24. The apparatus of claim 23, further comprising:
means for restarting the timer based at least in part on transmitting the indication of the second video streaming parameter prior to expiration of the timer;
means for receiving the one-way video transmissions associated with the video service according to a second video quality;
means for determining the second video quality fails to satisfy the second video streaming parameter prior to expiration of the restarted timer; and
means for transmitting an additional indication of a third video streaming parameter based at least in part on the determining.

25. The apparatus of claim 21, further comprising:
means for receiving the one-way video transmissions associated with the video service according to a second video quality based at least in part on transmitting the indication of the second video streaming parameter, the second video quality satisfying the second video streaming parameter.

26. The apparatus of claim 21, further comprising:
means for receiving the one-way video transmissions associated with the video service according to a second video quality based at least in part on transmitting the indication of the second video streaming parameter; and
means for determining the second video quality fails to satisfy the second video streaming parameter; and
means for transmitting an additional indication of a third video streaming parameter based at least in part on determining the second video quality fails to satisfy the second video streaming parameter

27. The apparatus of claim 21, further comprising:
means for determining that the second video streaming parameter comprises a lowest configured video streaming threshold for the first UE; and
means for transmitting, to the network entity, an indication to disable the video service based at least in part on the second video streaming parameter comprising the lowest configured video streaming threshold for the first UE.

28. The apparatus of claim 21, wherein:
the first video streaming parameter, the second video streaming parameter, or both comprise a supported codec and a profile level corresponding to a bitrate supported by the first UE associated with receiving the one-way video transmissions.

29. The apparatus of claim 21, wherein:
the first video streaming parameter, the second video streaming parameter, or both comprise a threshold quality of service, a bandwidth, a bit rate, a video resolution, or a combination thereof.

30. A non-transitory computer-readable medium storing code for wireless communications at a first user equipment (UE), the code comprising instructions executable by a processor to:
transmit a request to a network entity to establish a voice communication session with a second UE;
transmit an indication to the network entity of a first video streaming parameter associated with a video service, wherein the video service is configured for streaming one-way video transmissions from the network entity to the first UE for display at the first UE during establishment of the voice communication session with the second UE based at least in part on a subscription of the second UE to the video service;
receive one-way video transmissions associated with the video service during the establishment of the voice communication session with the second UE, the one-way video transmissions having a first video quality at the first UE; and
transmit an indication of a second video streaming parameter associated with the video service based at least in part on the first video quality at the first UE failing to satisfy a threshold video quality at the first UE for the video service.
